(19) United States
(12) Patent Application Publication
(10) Pub. No.: US 2004/0144465 A1
(43) Pub. Date: Jul. 29, 2004

(54) Vehicle extrication device

(76) Inventor: Eli Tiar, Ramat (IL)

Correspondence Address: Daniel J Swirsky, AlphaPatent Associates, PO Box 2345, Beit Shemesh, 99544, IL

(21) Appl. No.: 10/476,643

(22) PCT Filed:
(86) PCT No.: PCT/IL02/00352

(30) Foreign Application Priority Data
May 6, 2001 (IL) 142985

(51) Int. Cl. B60C 7/22

(52) U.S. Cl. 152/170

(57) ABSTRACT

According to the present invention is suggested a traction device for extricating a power driven wheel vehicle. The device comprises a strap assembly connected at one end to the vehicle wheel and at the other end to an external anchor/s. The strap assembly is made of pair of elastic straps interconnected by stretching cross straps at longitudinally spaced locations. The straps are connected at one end to the vehicle wheel and attached at the other end to an external anchor.

### BACKGROUND OF THE INVENTION

The present invention relates to vehicle extrication devices and more particularly to straps assembly enabling self-extrication of vehicle.

Various extrication devices exist for improving traction between the wheels of a land vehicle and a road surface in various conditions. Some of the practical devices in use are mattress type, placed partially beneath the vehicle wheel such that a non-skid surface or ramp is formed upon which the wheel may extricate itself by powered rotation.

Such devices body is normally provided with a gripping surface on its top side for generating significant frictional forces when brought into contact with the external surface of the vehicle wheel. One of the identified problems associated with prior art traction devices is that they are often difficult to position beneath the vehicle's wheels as in many cases, the wheels of a vehicle are mired in snow or mud for some depth.

Various devices have been developed for adding traction to the vehicle in ice, snow, mud or other conditions. Most of these devices which known as tire chains are adapted to remain affixed to the tire over extended distances.

Other devices have been adapted for use only for short distances to remove a stuck automobile and are not adapted to remain on the tire as the vehicle is driven over extended distances. Conventional tire chains are characterized by elongated flexible link chains connected at longitudinally spaced intervals by flexible cross link chains. Such tire chain is described in U.S. Pat. No. 3,867,794. The main disadvantage with the use of such tire chain is its awkward design and construction. The tire chain is intended to be wrapped around the wheel during the extraction operation, but as result of its heavy construction, it is most probable the chain will be stacked around the wheel at early stage of the operation. More over, the tire chain is heavy and cumbersome, hence it can't be operated by any driver.

Therefore, a long-standing need has existed to provide a novel traction device for self extrication of vehicles.

It is thus a prime object of the invention to avoid at least some of the limitations of the prior art and to provide traction device enabling self extrication of vehicles.

### SUMMARY OF THE INVENTION

A traction device for extricating a power driven wheel vehicle comprising at least one straps assembly connected at one end to the vehicle wheel and at the other end to an external anchor/s, said strap assembly comprising of: A pair of elastic straps interconnected by stretching cross straps at longitudinally spaced locations; first connecting means for attaching the straps assembly to the vehicle wheel and a second connecting means for attaching the straps assembly to an external anchor;

### BRIEF DESCRIPTION OF THE DRAWINGS

These and additional features and advantages of the present invention will become more clearly understood in the light of the ensuing description of a preferred embodiment thereof, given by way of example only with reference to the accompanying drawings, wherein—

FIG. 1 is a top view of the straps assembly according to the present invention;

FIG. 2 is a side view of the straps assembly according to the present invention;

FIG. 3 is a perspective top view of the straps assembly according to the present invention.

FIG. 4 illustrates an enlarge partial view of the straps assembly according to the present invention;

FIG. 5 illustrates an enlarge view of the fastening straps of the straps assembly passed around the tire;

FIGS. 6,7,8,9 and 10 illustrate the operation of forward extrication for front wheel drive vehicle using the straps assembly according to the present invention;

FIGS. 10,11,12,13 and 14 illustrates the operation of forward extrication for rear wheel drive vehicle using the straps assembly according to the present invention;

### DETAILED DESCRIPTION OF THE PREFERRED EMBODIMENTS

The present invention provides a traction device comprised of at least one strap assembly enabling self extrication of vehicles.

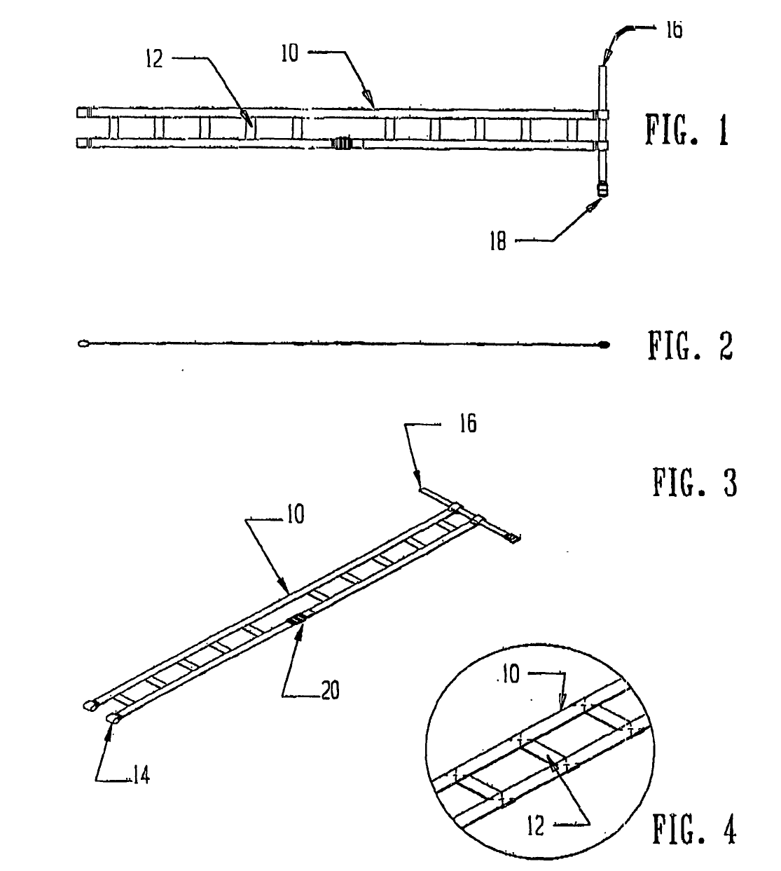

As seen in FIG. 1, the strap assemblies are comprised of two straps 10 interconnected by short cross straps 12 at longitudinally spaced locations The leading ends are forming enclosed loops 14(see FIG. 3). On one end, the loops can be connected to any external anchor and on the other end the loops are connected to the fastenings strap 16.

At least one of the straps of each straps assembly comprises a locking tension buckle 20. Such add-on buckle enables to use the straps assemblies for forward extrication of rear wheel drive vehicles.

The locking buckle 20 is located at fix distance from the straps ends adapted to the distance between the rear wheel and the front wheel of conventional vehicles. The fix distance is a slightly longer than needed, in case the actual distance is shorter than the fix distance, the straps are loosened, adapted to the actual distance.

According to the present invention it is suggested that the long straps 10 and cross straps 12 are made of flexible soft strong material such as cloth/nylon-web reinforced. The width in between the straps 10 is fix according to width of privet conventional vehicles adapted to use for all tire's size.

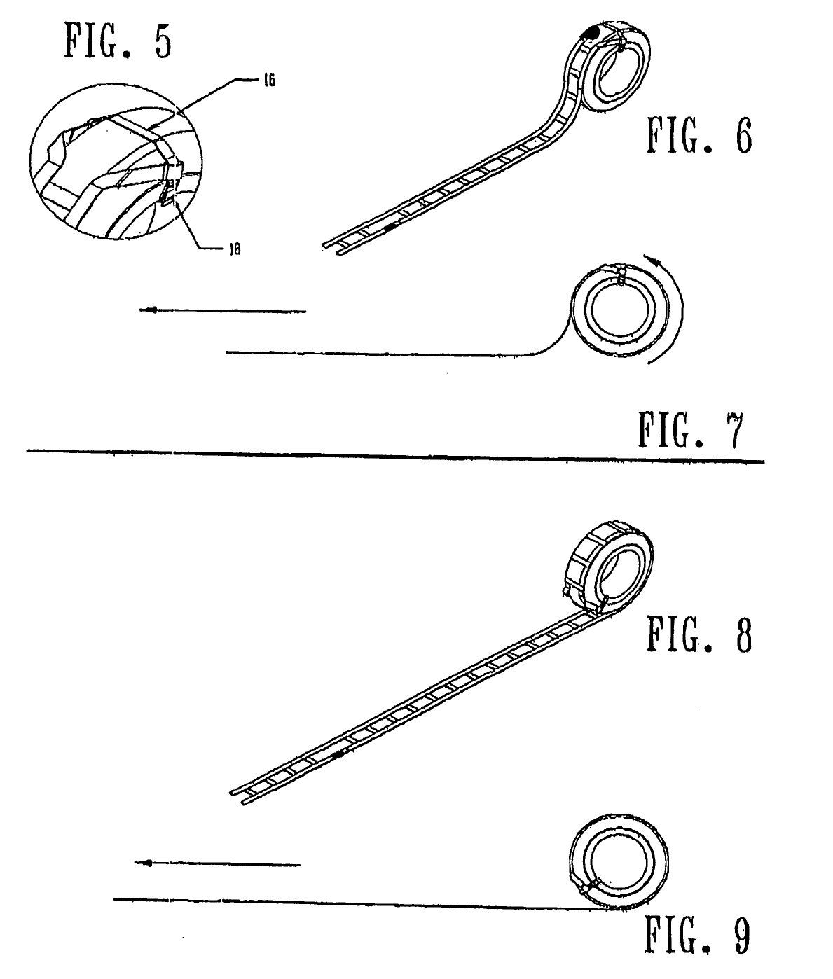

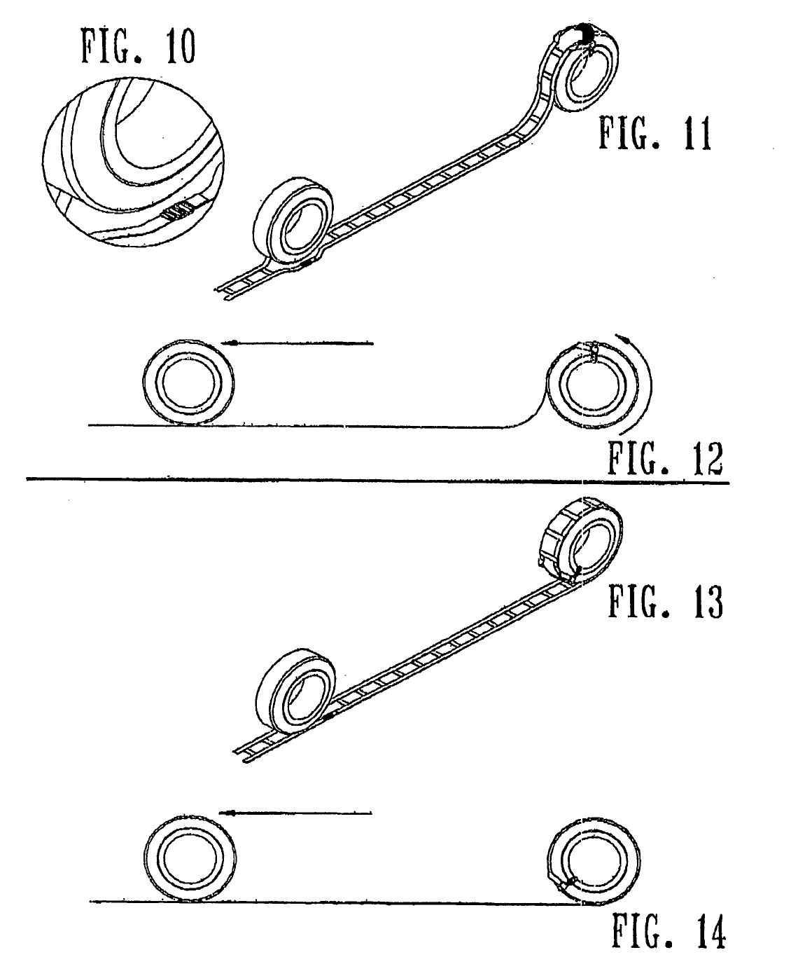

As seen in FIG. 5 the fastening strap 16 has a locking buckle 18, the fastening straps are wrapped around the tire, interconnected to the wheel and locked by the buckle 18.

For extricating the vehicle one can use single straps assembly, or two straps assemblies (one for each wheel) according to the vehicle traction type.

The method of using the straps assemblies for forward extrication, adapted to front wheel drive vehicle, is illustrated in FIGS. 5, 6,7,8 and 9. First the fastening straps are attached to each tire as seen in FIGS. 5 and 6, then the straps are laid along the ground in alignment with intended path of travel of the wheels and the free ends of the straps loops are attached to any external anchor/s, such as wedge stacked in the ground or any stable object. Once all attachments are completed the vehicle is driven forward slowly. As illustrated in FIGS. 7 and 8 the straps are wrapped around the tires as the vehicle wheel rotates. As a result the vehicle is pulled forward extricating itself from the mud or any other obstacle. The described process is equivalent to a winch device operation, wherein the vehicle wheel acts as the winch drum.

Once the vehicle front wheels are located on safe ground, the straps loops are released from the external anchor/s, and then the vehicle can be further driven freely with no external aid.

The method of using the straps assemblies for forward extrication adapted to rear wheel drive vehicle, is illustrated in FIGS. 10,11,12,13 and 14. First the fastening straps are attached to the tires of the rear wheels as seen in FIGS. 10 and 11. Then the add-on buckle 20 is unlocked, thus enabling to lay the straps on the ground across the vehicle front bypassing the front wheel (as seen in FIG. 11). Then, the buckle 20 is locked and the free ends of the straps loops are attached to any external anchor/s, such as wedge stacked in the ground or any stable object. Once all attachments are completed the vehicle is driven forward slowly extracting itself in the same manner as described above.

When needed, the straps assembly may be easily extended by interconnecting a second strap assembly using the end loops.

It will be thus evident that the strap assembly as herein described, is of an extremely simple construction and low weight. Hence, the straps assembly can be easily handled by any driver not requiring any skills or significant strength and can be easily folded into small package and carried in the car.

While the above description contains many specificities, these should not be construed as limitations on the scope of the invention, but rather as exemplification of the preferred embodiment. Those skilled in the art will envision other possible variations that are within its scope. Accordingly, the scope of the invention should be determined not by the embodiment illustrated, but by the appended claims and their legal equivalents.

What is claimed is:

1. A traction device for extricating a power driven wheel vehicle comprising at least one straps assembly connected at one end to the vehicle wheel and at the other end to an external anchor/s, said strap assembly comprising of:
(a) A pair of straps interconnected by cross straps at longitudinally spaced locations;
(b) First connecting means for attaching the straps assembly to the vehicle wheel; and
(c) Second connecting means for attaching the straps assembly to an external anchor;

2. A traction device according to claim 1 wherein the first connecting means includes a locking buckle.

3. A traction device according to claim 1 wherein the second connecting means includes enclosed loops.

4. A traction device according to claim 1 wherein the straps are made of cloth/nylon-web reinforced.

5. A traction device according to claim 1 wherein the straps are made of fabric.

6. A traction device according to claim 1 wherein the straps stripes are made of rubber.

7. A traction device according to claim 1 wherein the straps are made of leather.

8. A traction device according to claim 1 adapted for rear drive wheel vehicle further comprising a connector located at a fix distance from the end of the straps, wherein the fix distance is matching the distance between the front and rear wheels of conventional vehicle.

9. A traction device according to claim 8 wherein the connector is a locking buckle.
